(19) United States
(12) Patent Application Publication
(10) Pub. No.: US 2025/0128891 A1
(43) Pub. Date: Apr. 24, 2025

(54) METHOD FOR HANDLING AN OBJECT TO BE GRIPPED BY MEANS OF A HANDLING SYSTEM COMPRISING AN END EFFECTOR AND HANDLING SYSTEM AND END EFFECTOR

(71) Applicant: J.Schmalz GmbH, Glatten (DE)

(72) Inventors: Walter Schaaf, Freudenstadt-Grüntal (DE); Tobias Eberhardt, Glatten (DE); Steffen Krieg, Waldenbuch (DE)

(73) Assignee: J.Schmalz GmbH, Glatten (DE)

(21) Appl. No.: 18/919,788

(22) Filed: Oct. 18, 2024

(30) Foreign Application Priority Data
Oct. 20, 2023 (DE) 10 2023 128 963.2

(51) Int. Cl. B65G 47/90

(52) U.S. Cl. CPC B65G 47/905

(57) ABSTRACT

A method (and a handling system) for handling an object to be gripped by a handling system that includes an end effector, a manipulator, a marking device for marking the object to be gripped, and a detection device for detecting the marking on the object to be gripped, the method involving picking up the object to be gripped by the end effector, marking the object to be gripped by the marking device, depositing the object to be gripped at a deposit location, and picking the object to be gripped back up by the end effector, involving detecting the marking by the detection device, aligning the end effector relative to the marking, and gripping the object to be gripped by the end effector.

### DESCRIPTION

The invention relates to a method for handling an object to be gripped by means of a handling system comprising an end effector for gripping the object to be gripped and a manipulator for moving the end effector. The invention also relates to such a handling system and to an end effector.

Handling systems are known in many ways from the prior art and are used, for example, in production environments to transport workpieces between two deposition locations or between a deposition location and a processing machine. Such handling operations typically include gripping the workpiece (e.g. from a deposition location), depositing the workpiece (e.g. at another deposition location or at a processing station of a processing machine) and then picking the workpiece back up again (e.g. to pass it from the deposition location to a packaging process or to feed it to a deposition location after being processed in the processing machine).

When picking the workpiece back up, the problem often arises that the workpiece is no longer gripped in exactly the same position, which can lead to problems in certain application situations, for example if the workpiece is to go through a plurality of consecutive processing processes.

To solve this problem, it has been proposed to deposit the workpiece into a centering apparatus or to use optical sensors to record a contour or geometry of the workpiece to thereby allow the workpiece to be picked back up in the precise position. Alternatively, it is also known to hold the workpiece during a processing process by means of the manipulator and the end effector and to track the manipulator of a movement of the workpiece during processing.

However, the known solutions are either not very flexible or require complex control and monitoring using costly sensor systems requiring a lot of maintenance.

The object addressed by the invention is that of picking the objects to be gripped back up in a simple and cost-effective manner with precise positioning.

This object is achieved according to the invention by a method having the features of claim 1. This is a method for handling an object to be gripped, in particular a workpiece, by means of a handling system. In this respect, the method is also a method for operating a handling system.

The handling system comprises an end effector for gripping an object to be gripped. In particular, the end effector comprises a gripping apparatus for gripping an object to be gripped. The handling system also comprises a manipulator, in particular a robot, for moving the end effector. The end effector can be connected to the manipulator via a coupling device. The handling system also comprises a marking device for marking, in particular temporarily, the object to be gripped. The handling system also comprises a detection device for detecting the marking on the object to be gripped. The detection device may be an identification device for identifying the marking. The marking device and/or the detection device can be movable by the manipulator. Preferably, the marking device and/or the detection device is arranged on the end effector.

Further optional embodiments and advantages of the handling system for carrying out the method according to the invention are described below with reference to the handling system as such, and therefore, in order to avoid repetition, reference is made to that disclosed below in relation thereto.

The method comprises the following steps, in particular in the order given below:
Picking up the object to be gripped by means of the end effector, which involves gripping the object to be gripped by means of the end effector, in particular by means of a gripping apparatus of the end effector. In order to grip the object to be gripped, the end effector can, for example, be placed on the object to be gripped by the manipulator and then a gripping effect of the end effector may be activated.
Marking the object to be gripped in a marking region as a geometric reference for aligning the end effector when picking the object to be gripped back up. In this respect, the object to be gripped is locally marked. Marking is done using the marking device. Marking may include applying a marking or a marking body to the object to be gripped. Marking may also include changing the object to be gripped, in particular a material of the object to be gripped. Marking is carried out in particular after gripping the object to be gripped by means of the end effector, preferably when the object to be gripped is gripped.
Depositing the object to be gripped at a deposition location. Depositing the object to be gripped involves in particular separating the object to be gripped and the end effector. Previously, the object to be gripped may have been moved to the deposition location by means of the manipulator after being picked up by the end effector. In this respect, between picking up the object to be gripped by means of the end effector and depositing the object to be gripped at the deposition location, the object to be gripped (or the end effector and the object to be gripped that is gripped thereby) can be moved to the deposition location. Marking the object to be gripped can take place before, during and/or after moving the object to be gripped. The deposition location can, for example, be a processing station of a processing system or a deposition location for the object to be gripped.
Picking the object to be gripped back up from the deposition location or from a different pickup location using the end effector. To do this, the end effector can first be moved (once again) into the vicinity of the object to be gripped using the manipulator. The previously created marking on the object to be gripped is then detected by means of the detection device and the end effector is aligned relative to the marking, in particular in parallel with a surface of the object to be gripped, in particular in order to grip the object to be gripped at the same position it was previously gripped. Detection and alignment can take place at the same time. The alignment can be carried out in such a way that the end effector is moved in parallel with a surface of the object to be gripped until the marking is arranged in a predetermined position relative to the end effector. After alignment, the object to be gripped is gripped by means of the end effector, in particular a gripping apparatus of the end effector.

In the proposed method, an object to be gripped is marked in this respect, in particular temporarily, as a geometric reference for determining the precise position of the gripping point for picking the object to be gripped back up. This makes it possible to provide a structurally simple way of picking an object to be gripped back up at the same position. Marking the object to be gripped is in particular automated.

The object to be gripped can in particular be a workpiece.

The pickup location can correspond to the deposition location (e.g. a storage site in an intermediate storage facility for objects to be gripped). The pickup location can also be different from the deposition location. For example, the deposition location can be a feed location for a processing machine and the pickup location can be an output location of the processing machine.

Between depositing the object to be gripped and picking the object to be gripped back up, a process of working with the object to be gripped or a process where the object to be gripped is processed can be carried out. In this respect, between depositing the object to be gripped at the deposition location and picking the object to be gripped back up, the method may comprise carrying out a process of working with the object to be gripped or a process where the object to be gripped is processed. Carrying out the work process or processing process may involve transferring the object to be gripped from the deposition location to a pickup location that is different from the deposition location.

Aligning the end effector relative to the marking in particular involves moving the end effector in parallel with a surface of the object to be gripped, in particular by means of the manipulator. Preferably, when aligning the end effector, the end effector is moved relative to the object to be gripped, in particular in parallel with a surface of the object to be gripped, until the marking is in a predetermined reference position relative to the end effector. The reference position can in particular be a position on the marking device. The detection process may in particular involve checking whether the marking is arranged at the reference position. In particular, alignment of the end effector is stopped when the detection device has detected that the marking is arranged at the reference position.

The marking can be detected in different ways, in particular depending on the type of marking. Detecting the marking may include capturing a visual image of the marking, in particular the object to be gripped. In particular, the detection device can comprise a camera. Detecting the marking can also involve capturing or measuring the geometry of the object to be gripped. Detecting the marking may also involve detecting a magnetic field. In particular, the detection device can comprise a magnetic field sensor, for example a Hall-effect sensor. Detecting the marking may also include detecting a temperature of the object to be gripped, in particular a local temperature difference. In particular, the detection device can comprise a temperature sensor, in particular an infrared sensor and/or thermal imaging camera. Detecting the marking may involve combinations of the types of detection described above.

The detection process may involve scanning the surface of the object to be gripped by means of the detection device. This can be realized, for example, by the detection device being fastened to the manipulator, in particular to the end effector, and being moved by the manipulator in parallel with the surface of the object to be gripped, in particular in a grid.

The marking can remain permanently on the object to be gripped. The marking can also remain on the object to be gripped only temporarily for a marking time. The marking can dissolve automatically after a marking time. The marking can also be actively removed or changed.

As part of an advantageous development, while the object to be gripped is being picked back up or thereafter, the marking can be (actively) changed, preferably removed from the object to be gripped. This can prevent the marking from interfering with further use of the object to be gripped. Furthermore, such a design makes it possible to reuse the marking (e.g. when the marking is designed as a marking body; see below). The marking can be removed using the marking device. In this respect, the marking device can be designed to remove a marking applied to the object to be gripped.

The object to be gripped can be marked in different ways.

Marking may involve applying, in particular temporarily, a marking body to the object to be gripped. In this respect, the marking device can be designed to apply a marking body to the object to be gripped. Applying the marking body can involve, for example, depositing, pressing, lowering or dropping a marking body onto the object to be gripped. Applying the marking body can also involve sticking the marking body to the object to be gripped, for example by means of a removable adhesive bond, electrostatic adhesion, or by means of gecko tape. Such a design is inexpensive to implement.

In an embodiment comprising a marking body, while the object to be gripped is being picked back up or thereafter, the marking body can be removed from the object to be gripped again, in particular by means of the marking device. For example, picking the object to be gripped back up can involve contacting and/or gripping the marking body, in particular by means of the marking device, in particular at the same time as the object to be gripped is gripped by means of the end effector. In particular, the marking body can be reusable. In an embodiment in which the marking body has been glued to the object to be gripped, removal of the marking body can involve peeling off the marking body, in particular by releasing the adhesive bond.

As part of an advantageous development, the marking body can comprise a permanent magnet or can be formed by a permanent magnet. In particular, marking the object to be gripped may comprise applying a permanent magnet to the object to be gripped. This is particularly advantageous for ferromagnetic objects to be gripped. Such a design is inexpensive to implement and enables the marking to be removed easily without leaving any residue. In addition, the use of a permanent magnet helps to securely hold the marking in the correct position on the object to be gripped, particularly in the case of ferromagnetic objects to be gripped.

In an embodiment comprising a permanent magnet, detection of the marking can involve detecting a magnetic field emitted by the permanent magnet, in particular by means of a Hall-effect sensor. In this respect, the detection device can comprise a magnetic sensor, in particular a Hall-effect sensor. Alternatively or additionally, detecting the permanent magnet may involve capturing the geometry of the permanent magnet.

Alternatively or additionally, marking the object to be gripped may involve applying a color marking, in particular one that is a different color to the object to be gripped, in a marking region of the object to be gripped. In this respect, the marking device can be designed to apply a color marking to the object to be gripped. The color marking can be applied in different ways. For example, applying the color marking may involve applying a color body or color strip to the object to be gripped. Applying the color body or color strip to the object to be gripped can involve gluing the color body or color strip to the object to be gripped, for example by means of a removable adhesive bond, electrostatic adhesion, or by means of gecko tape. The optional removal of the marking can then involve, for example, peeling off the color body or color strip, thereby releasing the adhesive bond. The color body or color strip can also be held on the object to be gripped by means of magnetic force. It is also conceivable for the application of the color marking to involve painting or spraying a quantity of paint onto the object to be gripped. The optional removal of the marking can then involve, for example, washing off, rubbing off or flame-treating the quantity of paint.

As mentioned above, marking the object to be gripped can, alternatively or additionally, involve modifying, in particular locally, a property of the object to be gripped, in particular a material of the object to be gripped.

As part of an advantageous development, marking the object to be gripped can involve modifying a magnetic polarization of the object to be gripped in a marking region of the object to be gripped. This is particularly advantageous if the object to be gripped is made of a magnetically polarizable, in particular ferromagnetic, material or comprises a magnetically polarizable, in particular ferromagnetic, material at least in a marking region. In this respect, the marking device can comprise a magnetization device, in particular a permanent magnet. Detecting the marking can then, for example, involve detecting a magnetic field. The optional modification or removal of the marking may involve counter-magnetizing, in particular demagnetizing, the marking region. It is also conceivable that modifying or removing the marking involves heating the marking region above a Curie temperature of the object to be gripped.

Alternatively or additionally, marking the object to be gripped may involve heating or cooling the object to be gripped in a marking region of the object to be gripped. In this respect, the marking process may involve locally introducing a quantity of heat. Such a design can be implemented particularly cost-effectively and easily. In such an embodiment, detecting the marking may involve detecting a local temperature difference, in particular measuring a surface temperature of the object to be gripped. For example, the detection device may comprise an infrared sensor and/or a thermal imaging camera.

The object stated at the outset is also achieved by a handling system according to claim 11. The handling system is designed in particular to carry out one of the methods described above. The optional features and advantages of the handling system described above in relation to the method can also be used to design the handling system according to claim 11. Likewise, the advantages and optional features of the handling system or its components explained below can serve to design the method according to claim 1.

The handling system comprises an end effector for gripping an object to be gripped, a manipulator for moving the end effector, a marking device for marking, in particular temporarily, the object to be gripped and a detection device for detecting the marking on the object to be gripped, in particular a position of the marking on the object to be gripped.

The manipulator can be designed in different ways. The manipulator can be designed as a single-axis or multi-axis system. Preferably, the manipulator is designed as a robot.

The end effector can be designed in different ways. In particular, the end effector comprises a gripping apparatus for gripping the object to be gripped. The end effector may comprise a magnetic gripping apparatus, in particular a magnetic gripper. The end effector may comprise a mechanical gripping apparatus, in particular a finger gripper or clamp. The end effector may comprise an adhesion gripper, in particular a gecko gripper. The end effector may also comprise a passive gripper. Preferably, the end effector comprises a negative pressure gripping apparatus, in particular a vacuum gripper, more particularly a surface vacuum gripper. The end effector can comprise a plurality of gripping apparatuses. The end effector may comprise combinations of the gripping apparatuses described.

The handling system in particular also comprises a control device for controlling the handling system. The control device interacts in particular with the manipulator, the end effector, the marking device and the detection device. Preferably, the control device is configured to control the manipulator depending on a position of the marking identified by the detection device.

In particular, the control device is designed to carry out one of the methods described above. Preferably, the control device has a non-volatile data storage device on which control instructions are stored, in particular saved, which, in particular when executed by a data processing system of the control device, prompt the control device to carry out one of the methods described above.

Preferably, the marking device and optionally the detection device are arranged on the end effector. In this respect, the end effector, marking device and detection device can be collectively moved by the manipulator. A design of this kind is particularly compact.

As part of an advantageous development, the marking device can be designed to apply a marking body to the object to be gripped and in particular to remove the marking body from the object to be gripped again. In such an embodiment, the detection device can be designed in particular for capturing a visual image of the marking body.

Alternatively or additionally, the marking device can be designed to apply a permanent magnet to the object to be gripped and in particular to remove the permanent magnet from the object to be gripped again. In such an embodiment, the detection device can in particular comprise a sensor device, in particular a Hall-effect sensor, for detecting a magnetic field.

Alternatively or additionally, the marking device can be designed to apply a color marking to the object to be gripped and in particular to remove it from the object to be gripped again. In such an embodiment, the detection device can be designed in particular for capturing a visual image of the color marking. As part of an advantageous embodiment, the marking device can be designed to apply, in particular to stick, a color body or color strip to the object to be gripped. In such an embodiment, the marking device can optionally be designed to remove the color body or color strip from the object to be gripped. The marking device can also be designed to apply a quantity of paint to the object to be gripped, in particular by painting or spraying. In such an embodiment, the marking device can optionally be designed to remove the quantity of paint from the object to be gripped, in particular to soak up or wipe off the quantity of paint.

Alternatively or additionally, the marking device can be designed to locally heat or cool the object to be gripped. For example, the marking device can comprise a heating device or cooling device designed for this purpose. In such an embodiment, the detection device can comprise a sensor device, in particular a temperature sensor, for detecting a temperature of the object to be gripped. In particular, the detection device can comprise an infrared sensor and/or a thermal imaging camera.

The object described above is also achieved by an end effector according to claim 13. The end effector comprises a gripping apparatus for gripping an object to be gripped and a marking device for marking the object to be gripped.

Preferably, the end effector also comprises a detection device for identifying the marking on the object to be gripped.

Preferably, the end effector also comprises a coupling device, in particular a robot flange, for coupling the end effector to a manipulator, in particular a robot.

The advantages and optional features of the end effector, the marking device and the detection device described above in connection with the handling system can also be used to design the end effector according to claim 13.

The invention is explained in more detail below with reference to the figures.

### In the Figures

FIG. 1 is a simplified schematic view of an embodiment of a handling system;

FIG. 2 is a simplified schematic view of an embodiment of an end effector; and

FIG. 3 is a flowchart for explaining an exemplary method for handling an object to be gripped using the handling system according to FIG. 1.

In the following description and in the figures, identical reference signs are in each case used for identical or corresponding features.

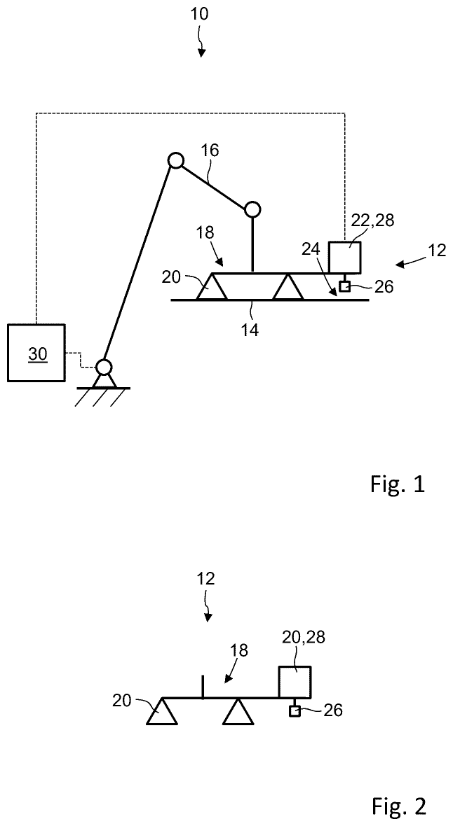

FIG. 1 shows, in a simplified schematic representation, an exemplary embodiment of a handling system, which is denoted as a whole by reference sign 10.

The handling system 10 comprises an end effector 12 for gripping an object to be gripped 14 and a manipulator 16 for moving the end effector 12. The end effector 12 is connected to the manipulator 16, for example via a coupling device (not shown).

The end effector 12 has a gripping apparatus 18, which, in the example, is designed as a vacuum gripper having a plurality of suction bodies 20. In embodiments that are not shown, the end effector 12 can also have any other gripping apparatuses (e.g. magnetic, mechanical or passive).

The handling system 10 also comprises a marking device 22 for marking the object to be gripped 14 in a marking region 24. In the example, the marking device 22 is designed to apply a marking body 26 to the object to be gripped 14 and optionally to remove it again from the object to be gripped 14 (explained in more detail below).

The marking body 26 can be, for example, a color body or a permanent magnet. In embodiments that are not shown, the marking device 22 can also have different designs, for example for modifying a magnetic polarization of the object to be gripped 14 in the marking region 24 or designed for heating or cooling the object to be gripped 14 in the marking region 24 (see above).

The handling system 10 also comprises a detection device 28 (integrated in the marking device 22 in the example) for detecting the marking or the marking body 26.

As mentioned above, the detection device 28 can have different designs depending on the design of the marking device 22. In the example shown, the detection device 28 is designed, for example, to capture a visual image of the marking body 26.

By way of example, the marking device 22 and the detection device 28 are preferably part of the end effector 12. In particular, the marking device 22 and the detection device 28 can be held on a support of the gripping apparatus 18. In embodiments that are not shown, the marking device 22 and/or the detection device 28 can be provided separately from the end effector 12, for example connected to the manipulator 16 via a separate connecting device.

The handling system 10 also comprises a control device 30 which is designed to control the manipulator 16. The control device 30 is also designed to control the marking device 22 and the detection device 28. The control device 30 is also designed in particular to control the gripping apparatus 18.

As mentioned above, the control device 24 preferably comprises a non-volatile data storage device (not shown) on which control instructions for the control device 30 are stored.

The manipulator 16 (shown only schematically in FIG. 1) is preferably designed as a robot. For example, the manipulator 16 can be a 6-axis robot. It is also possible that the manipulator 16 has only one driven axis, e.g. a linear axis.

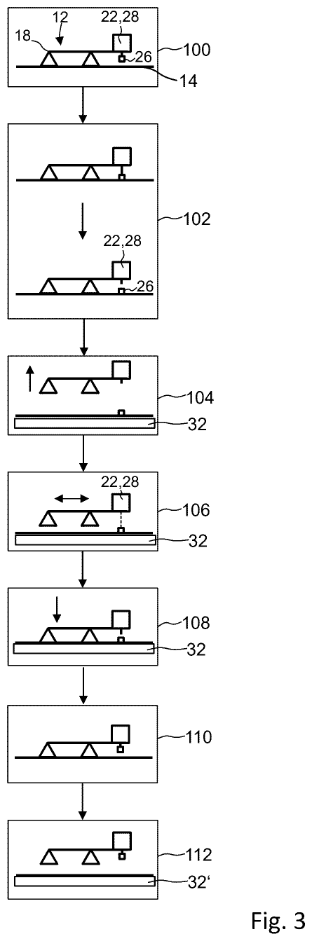

In the following, an exemplary method for handling an object to be gripped 14 by means of the handling system 10 will be described with reference to FIG. 3. However, the method is not limited to the specific design of the handling system 10 according to FIG. 1.

In a first step (block 100 in FIG. 3), the object to be gripped 14 is gripped by means of the gripping apparatus 18, for example from a deposition location of the object to be gripped 14. For this purpose, the gripping apparatus 18 can be placed on the object to be gripped 14 by means of the manipulator 16 and the object to be gripped 14 can then be drawn in via the suction bodies 20 (not shown separately in FIG. 3).

In a further step (block 102 in FIG. 3), the object to be gripped 14—when gripped by the gripping apparatus 18—is marked by means of the marking device 22. In the example, the marking device 22 places the marking body 26 on the object to be gripped 14 for this purpose.

The object to be gripped 14 is then placed at a desired deposition location 32, for example a deposition location or a processing station of a processing machine, and the end effector 12 or the gripping apparatus 18 is separated from the object to be gripped 14 (block 104 in FIG. 3). As indicated in block 106 in FIG. 2, the manipulator 16 can now optionally move away from the deposition location 30, for example to couple another end effector 12. The marking body 26 remains at the deposition location 32 together with the object to be gripped 14.

If the object to be gripped 14 is to be picked up again, the end effector 12 is moved back to the deposition location 30 and the end effector 12 is aligned relative to the marking body 26 (block 106 in FIG. 3). In the example, the end effector 12 is aligned such that the marking device 22 is positioned above the marking body 26 once again. As mentioned above, in order to align the end effector 12, said effector can be moved in parallel with the surface of the object to be gripped (shown by way of example by the double-headed arrow in block 106) and a position of the marking body 26 can be detected by means of the detection device 28.

If the end effector 12 is aligned such that the marking body 26 is in a specific reference position relative to the end effector 12 (in the example, below the marking device 22), the end effector 12 is placed back on the object to be gripped 14 and the object to be gripped is gripped by means of the gripping apparatus 18 (block 108 in FIG. 3).

In an optional further step (block 110 in FIG. 3), the marking is then removed from the object to be gripped 14 again. In the example, the marking body 26 is picked up again by the marking device 22 for this purpose. The marking body 26 can be reused for another gripping procedure.

The end effector 12 (and the object to be gripped 14 held thereby) can then be moved by the manipulator 16 to a further deposition location 32′ (e.g., another deposition location or to a processing machine) and deposited there (block 114 in FIG. 2).

The removal of the marking body 26 in step 110 can also take place during movement of the end effector 12 to the further deposition location 32′ or after the object to be gripped 14 has been deposited at the further deposition location 32′.

In the method outlined above by way of example, the deposition location 32 at which the object to be gripped 14 is deposited in step 104 and the pickup location at which the object to be gripped is gripped again in step 108 are identical. The deposition location 30 is therefore also a pickup location. As mentioned above, the pickup location may also be different from the deposition location 32. For example, it is conceivable that the deposition location 32 is a feed location for a processing machine and the object to be gripped 14 is subjected to a processing process after being deposited at this feed location (i.e. in FIG. 2, between steps 104 and 106) during which the object to be gripped 14 is brought to an output location of the processing machine which is different from the feed location. The object to be gripped 14 can then be picked back up at the output location of the processing machine.

1. A method for handling an object to be gripped by a handling system including
an end effector for gripping the object to be gripped,
a manipulator for moving the end effector;
a marking device for marking the object to be gripped, and
a detection device for detecting the marking on the object to be gripped,
the method comprising:
picking up the object to be gripped by the end effector, which involves gripping the object to be gripped by the end effector;
marking the object to be gripped by the marking device;
depositing the object to be gripped at a deposition location;
picking the object to be gripped back up by the end effector, which involves
detecting the marking by the detection device
aligning the end effector relative to the marking;
gripping the object to be gripped by the end effector.

2. The method according to claim 1, wherein aligning the end effector involves moving the end effector relative to, and in parallel with, a surface of the object to be gripped until the marking is in a predetermined reference position relative to the end effector.

3. The method according to claim 1, wherein detecting the marking involves capturing a visual image or geometry of the marking.

4. The method according to claim 1, further comprising, while the object to be gripped is being picked back up or thereafter: changing or removing the marking, by the marking device.

5. The method according to claim 1, wherein the marking process involves applying a marking body to the object to be gripped.

6. The method according to claim 1, wherein marking the object to be gripped involves applying a permanent magnet to the object to be gripped.

7. The method according to claim 6, wherein detecting the marking involves detecting a magnetic field emitted by the permanent magnet, by a magnetic field sensor or by a Hall-effect sensor.

8. The method according to claim 1, wherein marking the object to be gripped involves applying a color marking to the object to be gripped.

9. The method according to claim 1, wherein the object to be gripped is made of a magnetically polarizable material or comprises a magnetically polarizable ferromagnetic material at least in a marking region, wherein marking the object to be gripped involves changing the magnetic polarization of the object to be gripped in the marking region, wherein the removal of the marking involves counter-magnetizing the marking region or heating the marking region above a Curie temperature of the object to be gripped.

10. The method according to claim 1, wherein marking the object to be gripped involves heating or cooling the marking region of the object to be gripped, wherein detecting the marking involves detecting a local temperature difference in the object to be gripped, by an infrared sensor or a thermal imaging camera.

11. A handling system for carrying out the method according to claim 1, the handling system comprising
the end effector for gripping the object to be gripped;
the manipulator for moving the end effector;
the marking device for marking the object to be gripped;
the detection device for detecting the marking on the object to be gripped; and
the control device for controlling the handling system.

12. (canceled)

13. An end effector for use in the handling system according to claim 11, the end effector comprising a gripping apparatus or a suction gripper, for gripping an object to be gripped and the marking device for marking the object to be gripped.

14. The end effector according to claim 13, further comprising the detection device (28) for identifying the marking on the object to be gripped.

15. The handling system according to claim 14, wherein the marking device is designed to apply a marking body to the object to be gripped or to remove the marking body again.

16. The handling system according to claim 14, wherein the marking device is designed to apply a permanent magnet to the object to be gripped, wherein the detection device comprises a sensor device for detecting a magnetic field emitted by the permanent magnet.

17. The handling system according to claim 14, wherein the marking device is designed to apply a color marking to the object to be gripped, wherein the detection device comprises a camera for capturing a visual image of the color marking.

18. The handling system according to claim 14, wherein the marking device is designed to locally heat or cool the object to be gripped, wherein the detection device comprises a sensor device or a temperature sensor, for detecting a temperature of the object to be gripped.

19. A handling system comprising:
an end effector for gripping an object to be gripped;
a manipulator for moving the end effector;
a marking device for marking the object to be gripped;
a detection device for detecting the marking on the object to be gripped; and
a control device for controlling the handling system.
